(19) United States
(12) Patent Application Publication
(10) Pub. No.: US 2023/0377064 A1
(43) Pub. Date: Nov. 23, 2023

(54) Method for Controlling Power Exchanges and Heat Exchanges Between a Plurality of Energy Systems by Means of a Central Control Platform

(71) Applicant: Siemens Aktiengesellschaft, München (DE)

(72) Inventors: Stefan Niessen, Erlangen (DE); Sebastian Schreck, Nürnberg (DE); Sebastian Thiem, Neustadt an der Aisch (DE)

(73) Assignee: Siemens Aktiengesellschaft, München (DE)

(21) Appl. No.: 18/247,723

(22) PCT Filed: Jul. 22, 2021
(86) PCT No.: PCT/EP2021/070507

§ 371 Date: Apr. 3, 2023

(30) Foreign Application Priority Data
Oct. 6, 2020 (DE) 10 2020 212 610.0

(51) Int. Cl. G06Q 50/06; G05B 13/04; H02J 13/00; G06Q 30/018

(52) U.S. Cl. CPC G06Q 50/06; G05B 13/042; H02J 13/00002; G06Q 30/018

(57) ABSTRACT

Various embodiments include a method for controlling electricity exchanges and heat exchanges among a plurality of energy systems using a central control platform, wherein electricity exchange takes place via an electricity network and heat exchange via a heat network. The method may include: calculating a mathematical optimization at the control platform of power corresponding to the electricity exchanges and the heat exchanges; calculating the powers corresponding to the electricity exchanges and heat exchanges satisfies network boundary conditions of the electricity network; and implementing the electricity exchanges and heat exchanges between the energy systems based on the calculated powers. The optimization is based on an objective function including a coupling between electricity exchanges and heat exchanges.

### CROSS-REFERENCE TO RELATED APPLICATIONS

This application is a U.S. National Stage Application of International Application No. PCT/EP2021/070507 filed Jul. 22, 2021, which designates the United States of America, and claims priority to DE Application No. 10 2020 212 610.0 filed Oct. 6, 2020, the contents of which are hereby incorporated by reference in their entirety.

### TECHNICAL FIELD

The present disclosure relates to power and heat exchanges. Various embodiments include a methods and/or systems for controlling power and/or heat exchanges.

### BACKGROUND

Energy systems, for instance town boroughs, municipalities, industrial installations, industrial buildings, office buildings and/or residential buildings, can exchange energy in the form of electricity or heat between one another, for example by means of an electricity network and/or heat network (supply networks), in a decentralized manner, i.e. locally. In terms of technology, a local energy market platform can facilitate this local energy exchange (energy transfer/power exchange/power transfer). In this case, the energy systems communicate to the local energy market platform, in advance, offers for energy consumption and/or energy provision, in particular energy generation. On the basis thereof, the local energy market platform coordinates the energy exchanges optimally between the energy systems via the associated supply networks.

In other words, a local energy market is realized in terms of technology by the local energy market platform, which forms a control platform. Document EP 3518369 A1, for example, discloses one such local energy market platform/control platform for exchanging electrical energy. A local energy market allows the energy systems to exchange and trade amongst one another locally generated energy, in particular electrical energy (electricity). By virtue of its decentralized technical design, the local energy market allows the locally generated energy to be efficiently coordinated with local energy consumption. Hence a local energy market is advantageous especially with regard to renewable energies, which are typically generated locally.

In known energy markets, the offers preceding the energy exchanges consist of a maximum price for an amount of energy to be drawn or consumed, and/or a minimum price for an amount of energy to be provided. No further information is communicated. This leaves unconsidered any potential synergies between the electricity network and the heat network.

### SUMMARY

The teachings of the present disclosure may be used to improve the technical synergies between an electricity network and a heat network in relation to a local energy market. As an example, some embodiments include a method for controlling electricity exchanges (41) and heat exchanges (21) between a plurality of energy systems (10) by means of a control platform (1) central to the energy systems (10), wherein the electricity exchanges (41) take place via an electricity network (4), and the heat exchanges (21) via a heat network (2), including: calculating by means of a mathematical optimization by the control platform (1) the powers corresponding to the electricity exchanges (41) and heat exchanges (21), wherein the optimization is based on an objective function that comprises a coupling (42) between electricity exchanges (41) and heat exchanges (21), and the calculation of the powers corresponding to the electricity exchanges (41) and heat exchanges (21) is performed such that network boundary conditions of the electricity network (4) are satisfied; and implementing the electricity exchanges (41) and heat exchanges (21) between the energy systems (10) in accordance with the calculated powers.

In some embodiments, the satisfying of the network boundary conditions of the electricity network (4) is ensured by means of a constraint within the optimization and/or by means of a load flow calculation.

In some embodiments, the electricity network (4) is a low-voltage network, and wherein the condition that the voltage of the electricity network (4) is within the range of 207 Volts to 253 Volts is used as a network boundary condition.

In some embodiments, the condition that the maximum permissible thermal limit currents of respective equipment of the energy systems (10) are not exceeded is used as a network boundary condition.

In some embodiments, the energy systems (10) each communicate to the control platform (1), before the calculating of the powers, an offer for the respective electricity exchanges (41) and/or heat exchanges (21).

In some embodiments, the total heat losses, the total heat turnover and/or the total emissions, in particular with regard to carbon dioxide, are used as the objective function.

In some embodiments, the control platform (1) calculates by means of the optimization the powers for a coming day, in particular the day ahead, that are optimum with regard to the objective function.

In some embodiments, the heat network (2) is formed by a community heat network, district heat network, community cooling network, district cooling network and/or steam network.

As another example, some embodiments include a control platform (1) for controlling electricity exchanges (41) and heat exchanges (21) between a plurality of energy systems (10), wherein the electricity exchanges (41) take place via an electricity network (4), and the heat exchanges (21) via a heat network (2), characterized in that the control platform (1) is designed to execute the following steps: calculating by means of a mathematical optimization by the control platform (1) the powers corresponding to the electricity exchanges (41) and heat exchanges (21), wherein the optimization is based on an objective function that comprises a coupling (42) between electricity exchanges (41) and heat exchanges (21), and the calculation of the powers corresponding to the electricity exchanges (41) and heat exchanges (21) is performed such that network boundary conditions of the electricity network (4) are satisfied; and implementing the electricity exchanges (41) and heat exchanges (21) between the energy systems (10) in accordance with the calculated powers.

### BRIEF DESCRIPTION OF THE DRAWINGS

Further advantages, features, and details of the teachings herein will emerge from the exemplary embodiments described below and with reference to the drawings, in which, schematically:

FIG. 1 shows a schematic representation of an energy market having a control platform incorporating teachings of the present disclosure; and

FIG. 2 shows a second schematic representation of an energy market having a control platform incorporating teachings of the present disclosure.

Identical, equivalent or functionally identical elements may be provided with the same reference signs in one of the figures or throughout the figures.

### DETAILED DESCRIPTION

Various embodiments of the teachings herein include a method for controlling electricity exchanges and heat exchanges between a plurality of energy systems by means of a control platform central to the energy systems, wherein the electricity exchanges take place via an electricity network, and the heat exchanges via a heat network, is characterized at least by the following steps: calculating by means of a mathematical optimization by the control platform the powers corresponding to the electricity exchanges and heat exchanges, wherein the optimization is based on an objective function that comprises a coupling between electricity exchanges and heat exchanges, and the calculation of the powers corresponding to the electricity exchanges and heat exchanges is performed such that network boundary conditions of the electricity network are satisfied; and implementing the electricity exchanges and heat exchanges between the energy systems in accordance with the calculated powers.

Some embodiments include a control platform for controlling electricity exchanges and heat exchanges between a plurality of energy systems, wherein the electricity exchanges take place via an electricity network, and the heat exchanges via a heat network, is characterized in that the control platform is designed at least to execute the following steps: calculating by means of a mathematical optimization by the control platform the powers corresponding to the electricity exchanges and heat exchanges, wherein the optimization is based on an objective function that comprises a coupling between electricity exchanges and heat exchanges, and the calculation of the powers corresponding to the electricity exchanges and heat exchanges is performed such that network boundary conditions of the electricity network are satisfied; and implementing the electricity exchanges and heat exchanges between the energy systems in accordance with the calculated powers.

The methods incorporating teachings of the present disclosure and/or one or more functions, features and/or steps of the methods can be computer-aided. In particular, the optimization is implemented by computer-aided means. For example, the optimization problem is solved numerically.

The heat exchanges can also be in the form of cold exchanges. In physics there is just heat and no cold. In engineering, however, the term “cold” is used, and typically characterizes warmth or a state at a temperature below the prevailing ambient temperature. Thus the term “heat” includes the engineering term “cold”. Hence the heat exchange can be a cold exchange, heat installations can be cooling installations, a heat load can be a cold load, heat consumption can be cold consumption, and/or the heat network can be a cooling network, in particular a community cooling network and/or district cooling network.

A local energy market is realized by an energy market platform, which can also be referred to as a control platform or energy trading platform. The local energy market platform can be cloud-based, and the exchange of the offers/data/information can be based on blockchains. The local energy market platform or control platform coordinates and controls the energy exchanges, i.e. the electricity exchanges and heat exchanges, between the energy systems on the basis of offers that the energy systems have communicated to said platform in advance.

The control, i.e. the determining of the energy exchanges (heat and/or electricity and/or other forms of energy, for instance chemical energy) or of the corresponding powers, is performed on the basis of an optimization (optimization method), i.e. a mathematical optimization. The optimization is based on an objective function, the value of which is meant to be maximized or minimized as far as possible. In other words, the powers corresponding to the electricity exchanges and heat exchanges are calculated in advance, for example for one day ahead. Hence the optimization is basically a simulation of, or a method for simulating, the operation of the plurality of the energy systems in terms of the energy exchanges between the energy systems. The objective function can quantify or model the total energy turnover, the total carbon dioxide emission, the total energy losses, and/or the total operating costs of all participating energy systems and/or of the supply networks.

Thus the objective function forms a mathematical model for the electricity exchanges and heat exchanges. In other words, the objective function describes a technical quantity of the electricity exchanges and heat exchanges that is associated with the electricity exchanges and heat exchanges. The technical quantity can be the total carbon dioxide emission that is associated with, or linked to, the energy exchanges. For instance, the objective function describes the total carbon dioxide emission according to the exchanged powers. In this example, the objective function is minimized by the optimization in order to be able to determine energy exchanges, or corresponding powers or power values, that are the optimum in terms of the total carbon dioxide emission.

In other words, the optimization according to the objective function is a simulation of the energy exchanges, on the basis of which simulation, and in terms of a technical quantity associated with the energy exchanges, optimum energy exchanges are determined, or rather sought as part of the optimization problem. The use of an objective function associated with a technical quantity of the overall system, and the optimization thereof (maximizing or minimizing thereof), allows improved and resource-conserving control of the energy exchanges (electricity exchanges and heat exchanges). In particular, the objective function comprises a linear combination of the powers corresponding to the energy exchanges. The powers are thus variables of the objective function, or rather the actual powers exchanged by the technology are represented as variables of the objective function. The values of these variables/powers are calculated by means of the optimization and used for the control of the actual powers/energy exchanges. For example, a result of the optimization is that an installation is meant to produce a specific cooling power during an hour of the day ahead. To do this, it takes a specific electrical power from the electricity network. This result is communicated to the relevant energy system, with the installation controlled according to the communicated result of the optimization. In other words, the installation then provides the specific cooling power during the hour of the day ahead.

A power within a time period results in a specific energy or amount of energy in this time period that is provided and/or consumed or exchanged. In this sense, the terms energy/energy exchanges and power/power exchanges are equivalent in the present invention and hence are interchangeable.

In particular, the powers are calculated for the day ahead, where for this purpose the day ahead can also be subdivided for the optimization into smaller time intervals in which the powers are constant (temporal discretization/resolution). For example, the day ahead, or any defined future time period, for instance a coming hour, is subdivided for the optimization into hours, particularly preferably into 15-minute intervals. Shorter time intervals, for example every minute, can be provided.

From a structural viewpoint, the IPCC Fifth Assessment Report in particular defines an energy system as: “All components related to the production, conversion, delivery and use of energy.”

An energy system typically comprises a plurality of energy conversion installations. Energy conversion installations are energy technology components of the energy system, in particular generating installations, consumption installations and/or storage installations for electricity (electrical energy) and/or heat (thermal energy). In the present document, the terms heat and thermal energy are deemed equivalent and not strictly differentiated (as would be correct from the physics viewpoint).

Each of the energy systems can comprise one or more of the following components as energy conversion installations: electricity generators, power-to-heat installations, in particular combined heat and power plants, gas boilers, diesel generators, electric boilers, heat pumps, compression refrigeration machines, absorption refrigeration machines, pumps, community heat networks, district heat networks, community cooling networks, district cooling networks, energy transfer lines, wind turbines or wind farms, photovoltaic installations, biomass installations, biogas installations, waste incineration plants, industrial installations, conventional power plants and/or the like.

The energy systems can feed out and/or feed in, i.e. exchange, electrical energy (electricity) via the electricity network, which is external to the energy systems. The energy systems can feed out and/or feed in, i.e. exchange, heat via the heat network, which is external to the energy systems. Hence the energy systems can exchange electrical energy and/or heat via said supply networks, i.e. electricity exchanges and heat exchanges take place. It is not necessary that all the energy systems are connected to the heat network for the heat exchange. For the present invention it is sufficient that at least one of the energy systems is coupled to the external heat network for the heat exchange (energy exchange).

The local energy market platform/control platform controls the energy exchanges (at least electricity exchanges and heat exchanges) in the sense that it communicates control signals to the respective energy systems, for instance communicates a price signal and/or the value of an electrical and/or thermal power to be fed in and/or fed out within a specified time period. In this sense, indirect control is provided. Although direct control is not necessary, it can be provided. The local control platform can also communicate corresponding technical control quantities, for example the form of energy (electricity or heat), the amount of energy and/or the time of the relevant energy provision or consumption, to the respective energy systems. The local control platform thus determines by means of the optimization method the control quantities, which in the present case comprise the powers or power values corresponding to the energy exchanges.

The term “control” here includes open-loop and closed-loop control.

In some embodiments, the energy systems can exchange electrical energy (electricity) via the electricity network, and heat via the heat network. These energy exchanges are controlled, i.e. coordinated, by the local control platform on the basis of an optimization for the energy systems as a whole. This allows optimum local harmonization of energy provision, in particular energy generation and energy consumption. In the present case, the local control platform controls the electricity exchange and the heat exchange between the energy systems. This is the case because the optimization objective-function on which the control is based comprises a coupling of both forms of energy. This advantageously ensures that it is fundamentally possible to realize synergies between the two forms of energy and their provision, in particular their generation, and their consumption. Both forms of the energy exchange are optimized as a whole by the local energy market platform.

In some embodiments, the optimization is implemented on the basis of the objective function. The objective function models a technical quantity associated with the overall system (set of energy systems and, if applicable, supply networks), for example emissions and/or energy turnover, which is meant to be minimized or maximized, i.e. to be as optimum as possible. According to the invention, the objective function comprises a coupling between the electricity exchanges and heat exchanges. This ensures according to the invention that the optimization takes into account technical synergies between the electricity network and the heat network. In other words, the result of the optimization, which in the present case comprises the powers corresponding to the energy exchanges within one or more time intervals/time periods, takes into account and respects optimally the synergies between the electricity network and the heat network with regard to the objective function, and, according to the invention, also with regard to the network boundary conditions of the electricity network.

In other words, the optimization is performed such that the network boundary conditions of the electricity network are satisfied. This ensures that the result of the optimization, i.e. the intended powers or power exchanges/energy exchanges respect the network boundary conditions of the electricity network. Network boundary conditions for the heat network can be provided analogously. These are less critical, however, because of the inertia of heat networks. The heat network or the thermal network thus acts as an energy store, and therefore the location for heat feed-in does not depend, at least within certain limits, on network boundary conditions. In contrast, within the electricity network or electrical network, the voltage and the thermal load capability are highly dependent on 14odellinn.

In order to comply with the voltage limits and/or current limits in medium-voltage networks and/or low-voltage networks, it is advantageous if active electrical power and/or reactive electrical power is fed in or fed out at specific nodes according to the network status. In order to comply with the electrical specification of the connected components, network operators are obliged to keep the voltage in the electricity network within prescribed tolerances (in Germany, for example, the Technical Connection Rules for Low-Voltage VDE-AR-N 4100 prescribe a nominal voltage+/−10 percent, i.e. 230 Volts+/−23 Volts). In addition, the maximum permissible thermal limit currents of the equipment must not be exceeded. Since said limit values can be infringed in the case of demand-driven feed-in or feed-out (consumption) by many energy systems (participants/players), a method is thus required that coordinates the feed-in or feed-out by the energy systems or coordinates the network load. The method according to the invention can achieve this by the optimization taking into account the network boundary conditions, or rather by the optimization being performed such that the network boundary conditions of the electricity network are satisfied.

In some embodiments, the spatially optimized operation of, for example, power-to-heat installations (P2H installations) at critical network points makes it simpler to integrate installations for generating electricity from renewable energy (renewable energy installations). This is the case because the voltage can be lowered by targeted drawing of active power by the P2H installations.

In some embodiments, a method makes it simpler to integrate additional electrical loads. For example, if several electric vehicles, in particular electric cars, are connected to a line for the purpose of charging, it is possible to prevent additional loads on this line being deployed for heat generation, for instance by a heat pump. This can prevent, or at least mitigate, thermal overload of the electricity network, or too severe a voltage drop, for instance below the voltage limit value. In addition, the required heat can be fed in at a further network node without infringing the network boundary conditions. The present optimization inherently takes into account the aforementioned issues by the coupling of the electricity network and the heat network and by taking into account the network boundary condition of the electricity network. This can be performed at the node level for the electricity network and/or heat network.

A further example is a market-based switch-on of electrical heat generators in the event of an otherwise too high local feed-in by one or more photovoltaic installations, which would lead to an inadmissible excessive rise in voltage. In other words, this is a possible solution of the optimization, i.e. the optimization recognizes, figuratively speaking, by means of the stipulated network boundary conditions, the inadmissible excessive rise in voltage, and seeks another solution that does not lead to an increase in voltage. This solution can then comprise the switch-on/turn-on of the aforementioned electrical heat generators.

In particular, by virtue of the advance calculation of the powers by means of one or more optimizations, it is possible to prevent in advance potential problems relating to the network boundary conditions, for instance problems such as too large a voltage drop or voltage rise. As a result, a direct immediate intervention as provided in the prior art, for instance using a ripple control signal to switch installations on and off, is no longer necessary, or has to be used only in unforeseen emergencies.

In some embodiments, there is a method and a central control platform for satisfying network boundary conditions in the electricity network by making use of the flexibility in the heat network.

In some embodiments, the satisfying of the network boundary conditions of the electricity network is ensured by means of a constraint within the optimization and/or by means of a load flow calculation. In other words, the objective function, or the value thereof, is maximized or minimized such that the one or more constraints are met. The optimization problem typically has additional, and therefore a plurality of, constraints. In other words, the constraints of the optimization problem comprise the network boundary conditions. This advantageously ensures that the solution of the optimization, which comprises the corresponding and intended powers for the energy exchanges, satisfies the network boundary conditions. Since the powers calculated or determined by solving the optimization problem are used as setpoint values for the actual powers or power exchanges between the energy systems, the actual powers/power exchanges/energy exchanges hence meet the network boundary conditions. Thus this ensures that the technical requirement to satisfy the network boundary conditions, which requirement is 17odellin by the aforementioned constraint, is fulfilled for the real or actual powers/power exchanges/energy exchanges. In addition, the constraint for the network boundary condition can comprise a plurality of conditions or constraints.

In some embodiments, the electricity network is a low-voltage network, and the condition that the voltage of the electricity network is within the range of 207 Volts to 253 Volts is used as a network boundary condition.

In other words, the constraint for the network voltage U is that, at every time instant considered and at every network node of the electricity network, it must meet the condition 207V≤U≤253V. Knowledge of the network structure or network topology of the electricity network can thus be advantageous for posing the constraint. In other words, the constraint can take into account the network 18odelliny of the electricity network.

In some embodiments, the condition that the maximum permissible thermal limit currents of respective equipment, for example of installations and/or components of the energy systems, are not exceeded is used as a network boundary condition. This can ensure that thermal overload does not take place.

In some embodiments, the energy systems each communicate to the control platform, before the calculating of the powers, an offer for the respective electricity exchanges and/or heat exchanges. The offers can comprise the network boundary conditions or further technical requirements, in particular technical conditions or requirements specific to the energy system. A typical purchase offer for a specific amount of heat/electricity (within a time period) provides at least a maximum price for each amount of heat/electricity and a maximum amount of heat/electricity to be bought. The purchase offer, or the information that it comprises, is communicated to the control platform by the associated energy systems. Similarly, a sales offer for a specific amount of heat/electricity (within a time period) provides at least a minimum price for each amount of heat/electricity and a maximum amount of heat/electricity to be provided, in particular generated. The energy systems can communicate the aforementioned technical network boundary conditions/conditions/requirements/data/information to the control platform, in particular as part of the offers, by means of an energy management system associated with the particular energy system, an edge device, in particular a trading agent.

In some embodiments, the total heat losses, the total heat turnover and/or the total emissions, in particular with regard to carbon dioxide, are used as the objective function. In this case, the optimization, i.e. the optimum possible matching of the offers, takes into account the coupling between the electricity network and the heat network. It is thereby possible to optimize the total emissions and/or the total energy turnover and/or the losses, each of which relate to both forms of energy, i.e. to heat and electricity.

In some embodiments, the control platform calculates by means of the optimization the powers for a coming day, in particular the day ahead, that are optimum with regard to the objective function. This advantageously allows more efficient day-ahead trading. Typically, an optimization for the day ahead based on the communicated information/data and satisfying the network boundary conditions is carried out for every hour, in particular every 15 minutes, of the specified day. The objective function can quantify or represent the total heat turnover, the total energy turnover, the total losses of the heat network (total heat losses) and/or of the electricity network, and/or the total operating costs. The aforementioned technical quantities, for example the total heat losses, are then maximized or minimized by the optimization. In particular in this case, electricity generators, heat generators, electricity stores, heat stores, electricity network and heat network are 20odellin and optimized as a whole, in order to be able to achieve optimum operation as a whole while satisfying the network boundary conditions of the electricity network.

In some embodiments, the heat network is formed by a community heat network, district heat network, community cooling network, district cooling network and/or steam network. This allows the use of existing heat networks, so that these can form, in conjunction with the control platform, a local heat market/energy market, or can be integrated in said market.

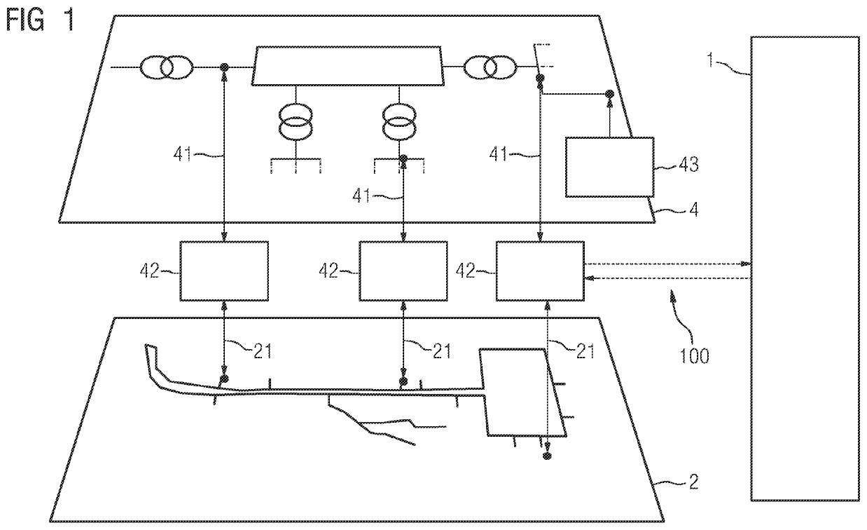

FIG. 1 shows a control platform 1 incorporating teachings of the present disclosure. The control platform 1 is designed to control electricity exchanges 41 and heat exchanges 21 between a plurality of energy systems. The electricity exchanges 21 take place via an electricity network 4, and the heat exchanges 41 take place via a heat network 2.

The energy systems and their energy technology installations are symbolized in FIG. 1 by a coupling 42 of the electricity network 4 and the heat network 2. In other words, a plurality of the energy systems comprise an energy technology installation, for instance a combined heat and power plant, a heat pump and/or an electric boiler, which couple an electrical power to a thermal power. This coupling of the electricity network 4 and the heat network 2 is symbolized by the reference sign 42. The present invention takes into account the coupling 42 of the two networks 2, 4.

The control platform 1 coordinates or controls the electricity exchanges 21, 41 between the energy systems. Therefore in this sense, it forms a unit central to the energy systems for coordinating the electricity exchanges 41 and heat exchanges 21. The control platform 1 thereby also forms a local energy market platform for exchanging and trading energy (electricity and heat) between the energy systems.

The energy systems communicate to the control platform 1, in advance, offers relating to an intended, in particular predicted, electricity exchange 41 and/or heat exchange 21, for instance for the day ahead. The control platform 1 optimally harmonizes by means of a mathematical optimization the offers for heat provision, in particular heat generation, and heat consumption and additionally for electricity provision, in particular for electricity generation and electricity consumption. The resolution here can equal one hour, particularly preferably 15 minutes. In other words, the control platform 1 performs said optimization every hour or every 15 minutes. The optimization is performed on the basis of an objective function, which, for example, models the total heat losses.

In addition, the optimization is performed under the constraint that network boundary conditions of the electricity network 4 are satisfied. This is done by formulating the technical network boundary conditions as constraints of the optimization problem or optimization. A corresponding network boundary condition can exist or be taken into account for a plurality of network nodes of the electricity network 4. In other words, the network topology of the electricity network 4 be taken into account within the constraints. What is crucial here is that the objective function on which the optimization is based comprises the coupling 42 of the electricity network 4 and the heat network 2. The heat network 2, because of its greater inertia compared with the electricity network 4, can thereby be used as a buffer/reserve for the electricity network 4, so that appropriate heat generation and/or appropriate heat consumption can prevent infringement of the network boundary conditions of the electricity network 4. This does not require any complex 22odelling or manual intervention, but instead the present invention facilitates this automatically and also optimally by taking the network boundary conditions of the electricity network 4 into account in the optimization.

In other words, the solution to the optimization problem respects the network boundary conditions of the electricity network 4. If the energy systems are each operated in accordance with the solution to the optimization problem, i.e. in accordance with the calculated powers, in the associated time period so that the calculated powers/power exchanges/energy exchanges take place, then this ensures that the network boundary conditions of the electricity network 4 are also satisfied in the actual electricity exchanges 41 and heat exchanges 21. In addition, network boundary conditions for the heat network 2 can be provided analogously.

The energy systems together comprise a plurality of power-to-heat installations, for example combined heat and power plants, heat pumps and/or electric boilers. The energy systems form, in conjunction with the control platform 1, a local energy market in terms of the exchange and trading of electrical energy and thermal energy. For the purpose of electricity exchange 41, the energy systems are connected to one another via the electricity network 4. For the purpose of heat exchange 21, the energy systems are connected to one another via the heat network 2. In addition, one of the energy systems has a photovoltaic installation.

For the energy exchanges 21, 41 which are meant to take place on the day after the current day, for example, the energy systems communicate one or more offers to the control platform 1. For example, the energy systems submit to the local energy market, i.e. to the control platform 1, offers for buying electrical energy and selling thermal energy. The energy system containing the photovoltaic installation communicates to the control platform 1 a sales offer for photovoltaic electricity.

It shall now be assumed that given full and unobserved feed-in by the photovoltaic installation, an inadmissible rise in voltage (network voltage above the limit value) would occur at the network connection point of the associated energy system. Without further control/monitoring, this would then happen as described. In the present case, however, the control platform 1 knows the electrical network boundary conditions, for example from the network operator of the electricity network 4. Alternatively or additionally, the control platform 1 can perform a load flow calculation to determine the network boundary conditions of the electricity network 4. The control platform 1 can thereby recognize, figuratively speaking, the voltage problem in advance or in good time.

An optimization is carried out in order to determine or calculate the powers corresponding to the energy exchanges 21, 41. Since the control platform 1 knows the network boundary conditions and the intended feed-in power, the optimization is performed such that, despite the communicated feed-in power, which would lead to a voltage problem, the network boundary condition is satisfied. In other words, the solution of the optimization respects the network boundary conditions. By virtue of the coupling of the electricity network 4 and the heat network 2, the optimization finds a solution that allows feed-in of the photovoltaic electricity (PV electricity) while satisfying the network boundary conditions of the electricity network 4. In the present exemplary embodiment, such a solution could be that heat or thermal energy is supplied to, or fed into, the heat network 2 by an electric boiler instead of by the heat pump. In other words, the optimization would determine a solution in which, at the time instant or during the time period of the PV feed-in and of the existence of a voltage problem, a power of the heat pump and/or electric boiler is non-zero. In addition, the corresponding powers of the heat pump and/or of the electric boiler would be determined or calculated optimally in such a way that precisely the voltage problem during the feed-in is eliminated. The voltage problem is hence solved optimally. As a result of said heat feed-in, the voltage falls at the line concerned of the electricity network 4, and the full PV power can be fed in.

The control platform 1 could also determine amongst a plurality of admissible optimization solutions the solution that smooths as much as possible, and/or keeps within the admissible tolerance band, power flows in the electricity network 4 and in the heat network 2, and the voltage profile in the electricity network 4

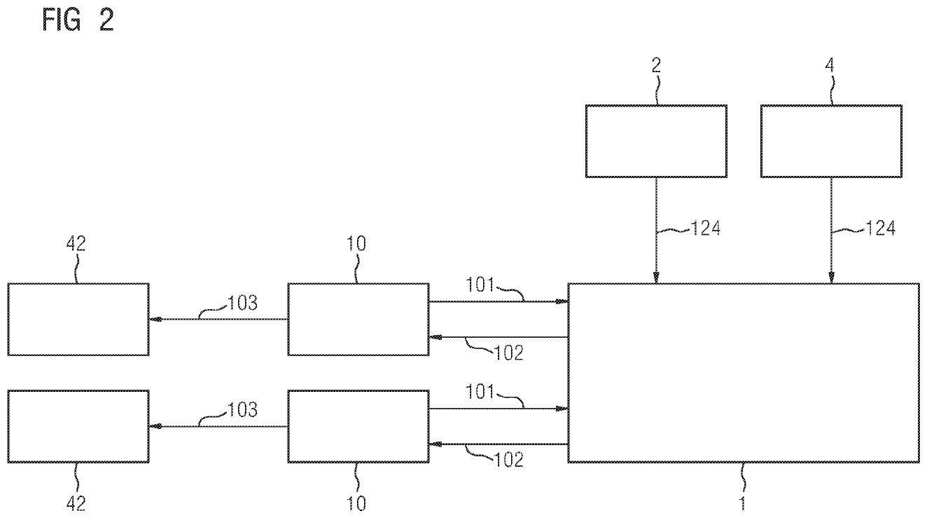

FIG. 2 shows a possible sequence of a day-ahead method, in which has been identified, for example by means of a load flow calculation, a voltage problem in the electricity network 4, and therefore the electric boiler would be operated instead of the heat pump. One of the energy systems 10 has an electric boiler, and another of the energy systems 10 has a heat pump. The electric boiler and the heat pump couple the electricity network 4 to the heat network 2, and therefore this is denoted by the same reference sign 42 as the coupling.

The energy systems 10 communicate to the control platform 1 offers for associated heat generation or heat feed-in. The communication of the respective offers is denoted by the arrows 101. The control platform 1 receives the offers from the energy systems 10, and on the basis thereof, performs an optimization in terms of matching the energy exchanges. In other words, the optimum operation of the electricity network 4 and of the heat network 2 is calculated in advance. This is done in compliance with network boundary conditions/network restrictions of the electricity network 4 and/or a load flow calculation relating to the electricity network 4. For this purpose, the network boundary conditions or the network restrictions and the network topologies of the electricity network 4, and additionally of the heat network 2, were communicated to the control platform 1, for instance by each network operator of said networks. This communication is denoted by the arrows 124.

The result (powers or power values) of the optimization, which takes into account the aforementioned network boundary conditions/network restrictions and/or the network topology, is communicated to the energy systems 10. This communication is denoted by the arrows 102. Within the energy systems 10, the result, so for instance in what time period the heat pump or the electric boiler will take what electrical power from the electricity network 4 and will feed corresponding heat power into the heat network 2, is converted into control signals for the installations and communicated to these installations. This communication is denoted by the arrows 103. The installations, i.e. in the present case the heat pump and the electric boiler, are thereby operated in accordance with the result of the optimization. In other words, the electricity exchanges and heat exchanges determined by the optimization are implemented or carried out on the basis of the calculated corresponding powers.

In addition, a shorter-term calculation by the control platform 1 than a day ahead is possible, for example on the basis of live measurement values that are communicated to said platform. This could allow a quick response to a suddenly occurring voltage problem by switching on or turning on the electric boiler.

Although the teachings of the present disclosure have been described and illustrated in more detail by way of the exemplary embodiments, the scope of the disclosure is not restricted by the disclosed examples or other variations may be derived therefrom by a person skilled in the art without departing from the scope of protection of the present disclosure.

### LIST OF REFERENCE SIGNS

1 control platform
2 heat network
4 electricity network
10 energy system
21 heat exchange
41 electricity exchange
42 coupling
43 photovoltaic feed-in
100 data connection
101 communication—offer
102 communication—calculated power/result
103 control signal
124 communication—network boundary conditions

What is claimed is:

1. A method for controlling electricity exchanges and heat exchanges among a plurality of energy systems using a central control platform, wherein electricity exchange takes place via an electricity network and heat exchange via a heat network, the method comprising:
calculating a mathematical optimization at the control platform of power corresponding to the electricity exchanges and the heat exchanges;
wherein
the optimization is based on an objective function including a coupling between electricity exchanges and heat exchanges;
calculating the powers corresponding to the electricity exchanges and heat exchanges satisfies network boundary conditions of the electricity network; and
implementing the electricity exchanges and heat exchanges between the energy systems based on the calculated powers.

2. The method as claimed in claim 1, wherein satisfying the network boundary conditions of the electricity network is ensured by means of a constraint within the optimization and/or by a load flow calculation.

3. The method as claimed in claim 1, wherein:
the electricity network comprises a low-voltage network; and
one of the network boundary conditions includes the voltage of the electricity network is kept within the range of 207 Volts to 253 Volts.

4. The method as claimed in claim 1, wherein one of the network boundary conditions include the maximum permissible thermal limit currents of respective equipment of the energy systems are not exceeded.

5. The method as claimed in claim 1, wherein the energy systems each communicate to the control platform, before the calculating of the powers, an offer for the respective electricity exchanges and/or heat exchanges.

6. The method as claimed in claim 1, wherein the objective function includes a total heat loss, a total heat turnover, and/or a total emission.

7. The method as claimed in claim 1, further comprising calculating the powers for a coming day optimized based on the objective function.

8. The method as claimed in claim 1, wherein the heat network comprises a community heat network, a district heat network, a community cooling network, a district cooling network, and/or a steam network.

9. A control platform for controlling electricity exchanges and heat exchanges between a plurality of energy systems, wherein electricity exchange takes place via an electricity network and heat exchange takes place via a heat network, the control platform comprising:
a controller configured to
calculate a mathematical optimization of the powers corresponding to the electricity exchanges and heat exchanges;
wherein the optimization is based on an objective function that comprises a coupling between electricity exchanges and heat exchanges; and
the calculation of the powers corresponding to the electricity exchanges and heat exchanges is performed such that network boundary conditions of the electricity network are satisfied; and
implementing the electricity exchanges and heat exchanges between the energy systems based on the calculated powers.
